(19) United States
(12) Patent Application Publication
(10) Pub. No.: US 2025/0274333 A1
(43) Pub. Date: Aug. 28, 2025

(54) SYSTEMS AND METHODS FOR REAL TIME MONITORING OF CLOUD RESOURCES

(71) Applicant: Capital One Services, LLC, McLean, VA (US)

(72) Inventors: Ebrima N. Ceesay, Vienna, VA (US); Nesreen Mansour, Great Falls, VA (US); Tao Xu, Clarksburg, MD (US); Siva Prasad Koka, Sterling, VA (US)

(21) Appl. No.: 18/587,776

(22) Filed: Feb. 26, 2024

(51) Int. Cl. H04L 41/0604; G06F 8/71; H04L 41/14

(52) U.S. Cl. CPC H04L 41/0604; G06F 8/71; H04L 41/14

(57) ABSTRACT

Disclosed embodiments may include a method for systems and methods for real time monitoring of cloud resources. The system may include one or more processors, and memory in communication with the one or more processors and storing instructions that, when executed by the one or more processors, are configured to cause the system to receive an indication of a code update to source code at a source code repository and that the second set of source code has been deployed to a cloud infrastructure. In some embodiments, receive an alert associated with an event at an alerting resource, identify one or more interrelated resources, and communicate with the cloud infrastructure to obtain a snapshot of resource states. In other embodiments, the memory can be further configured to cause the system to identify a previous update to source code, generate aggregated alert information, and determine a rectification action.

The disclosed technology relates to systems and methods for real time monitoring of cloud resources. Specifically, this disclosed technology relates to using a machine learning model and a graphical user interface to conduct real time monitoring of cloud resources.

### BACKGROUND

Companies use monitoring tools to increase security and provide situational awareness. However, traditional systems and methods for monitoring of cloud resources typically do not provide a unified shared situational awareness on the security posture. Traditional systems monitor and troubleshoot problems with applications, servers, and networks, which can be expensive to procure and maintain. Alert messages from multiple monitoring tools are usually not correlated and are typically only sent to individual application owners, thus lacking a comprehensive incident impact analysis across users. Determining the root cause of issues from multiple API calls from data sources along with shifting through collected data can be difficult and result in unreliable analytics.

Accordingly, there is a need for improved systems and methods for real time monitoring of cloud resources. Embodiments of the present disclosure are directed to this and other considerations.

### SUMMARY

Disclosed embodiments may include a system for systems and methods for real time monitoring of cloud resources. The system may include one or more processors, and memory in communication with the one or more processors and storing instructions that, when executed by the one or more processors, are configured to cause the system to receive an indication of a code update to source code at a source code repository. In some embodiments, the indication of the code update can represent replacing a first set of source code with a second set of source code. In some embodiments, the memory can be further configured to cause the system to receive an indication that the second set of source code has been deployed to a cloud infrastructure and receive an alert associated with an event at an alerting resource. In some embodiments, the alerting resource is one of a plurality of cloud resources hosted on the cloud infrastructure. In some embodiments, the memory can be further configured to cause the system to identify, based on the alert, one or more interrelated resources. In some embodiments, the one or more interrelated resources includes one or more resources of the plurality of cloud resources that may be impacted by the event at the alerting resource. In some embodiments, the memory can be further configured to cause the system to communicate with the cloud infrastructure to obtain a snapshot of resource states, identify a previous update to source code at the source code repository that is suspected of having caused the event, and generate aggregated alert information. In some embodiments, the aggregated alert information includes an indication of the alert, the snapshot of resource states and an indication of the previous update to source code suspected of having caused the event. In some embodiments, the memory can be further configured to cause the system to, responsive to outputting the aggregated alert information to a machine learning model, determine a rectification action.

Disclosed embodiments may include a system for systems and methods for real time monitoring of cloud resources. The system may include one or more processors, and memory in communication with the one or more processors and storing instructions that, when executed by the one or more processors, are configured to cause the system to receive an alert associated with an event at an alerting resource. In some embodiments, the alerting resource is one of a plurality of cloud resources hosted on a cloud infrastructure and identify, based on the alert, one or more interrelated resources. In some embodiments, the one or more interrelated resources includes one or more resources of the plurality of cloud resources that may be impacted by the event at the alerting resource. In some embodiments, the memory can be further configured to cause the system to communicate with the cloud infrastructure to obtain a snapshot of resource states, identify a previous update to source code at a source code repository that is suspected of having caused the event, and generate aggregated alert information. In some embodiments, the aggregated alert information includes an indication of the alert, the snapshot of resource states and an indication of the previous update to source code suspected of having caused the event. In some embodiments, the memory can be further configured to cause the system to, responsive to outputting the aggregated alert information to a machine learning model, determine a rectification action.

Disclosed embodiments may include a system for systems and methods for real time monitoring of cloud resources. The system may include one or more processors, and memory in communication with the one or more processors and storing instructions that, when executed by the one or more processors, are configured to cause the system to receive an alert associated with an event at an alerting resource. In some embodiments, the alerting resource is one of a plurality of cloud resources hosted on a cloud infrastructure. In some embodiments, the memory can be further configured to cause the system to identify, based on the alert, one or more interrelated resources. In some embodiments, the one or more interrelated resources includes one or more resources of the plurality of cloud resources that may be impacted by the event at the alerting resource. In some embodiments, the memory can be further configured to cause the system to communicate with the cloud infrastructure to obtain a snapshot of resource states, identify, a previous update to source code at a source code repository that is suspected of having caused the event, and output aggregated alert information for display via a graphical user interface (GUI) of a user device. In some embodiments, the aggregated alert information includes the alert, the snapshot of states and an indication of the previous update to source code.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for systems and methods for real time monitoring of cloud resources in accordance with certain embodiments of the disclosed technology.

FIG. 2 is a flow diagram illustrating an exemplary method for systems and methods for real time monitoring of cloud resources in accordance with certain embodiments of the disclosed technology.

FIG. 3 is a block diagram of an example alert monitoring system used to provide systems and methods for real time monitoring of cloud resources, according to an example implementation of the disclosed technology.

FIG. 4 is a block diagram of an example system that may be used to provide systems and methods for real time monitoring of cloud resources, according to an example implementation of the disclosed technology.

### DETAILED DESCRIPTION

Examples of the present disclosure related to systems and methods for real time monitoring of cloud resources. More particularly, the disclosed technology relates to using a machine learning model and a graphical user interface to conduct real time monitoring of cloud resources. The systems and methods described herein utilize, in some instances, machine learning models, which are necessarily rooted in computers and technology. Machine learning models are a unique computer technology that involves training models to complete tasks and make decisions. The present disclosure details a system relating to conducting real time monitoring by providing a unified shared situational awareness system. This, in some examples, may involve using aggregated alert information comprising of indications of an alert of a security event as input data and a machine learning model, applied to determine a rectification action to rectify the security event. Using a machine learning model in this way may allow the system to provide reliable actions and analytics to confront one or more security events by reducing the time to detect (TTD) and time to respond (TTR) to a security attack. This is a clear advantage and improvement over prior technologies that use multiple monitoring tools because multiple tools lack a comprehensive incident impact analysis which can be used to provide better rectification actions. Furthermore, examples of the present disclosure may also improve the speed with which computers can react to the security event across a plurality of users. Overall, the systems and methods disclosed have significant practical applications in the field because of the noteworthy improvement in security monitoring, which is important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

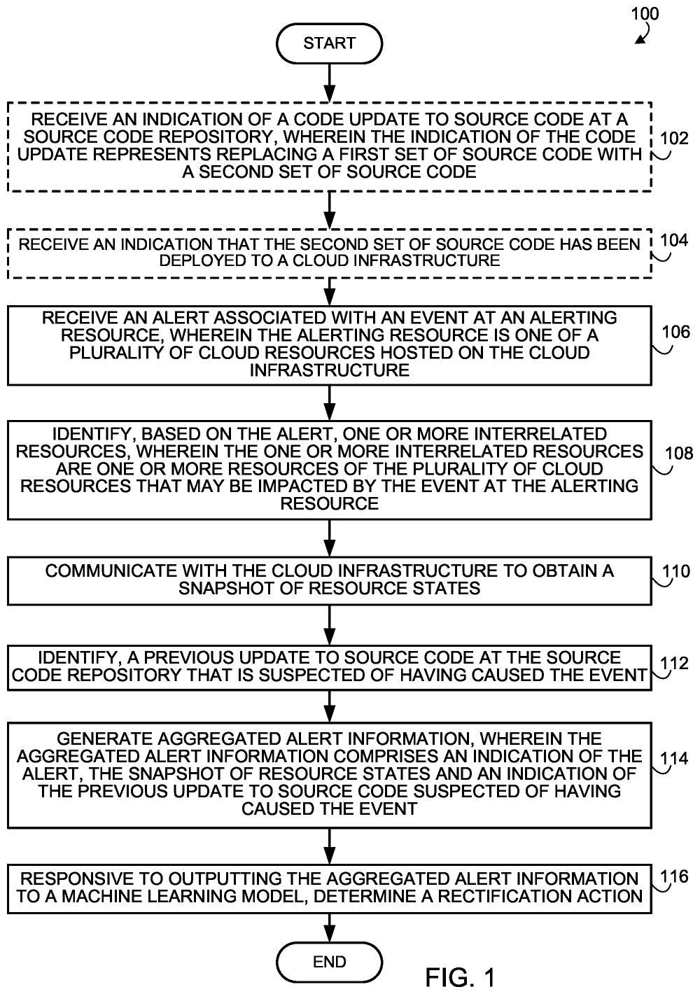

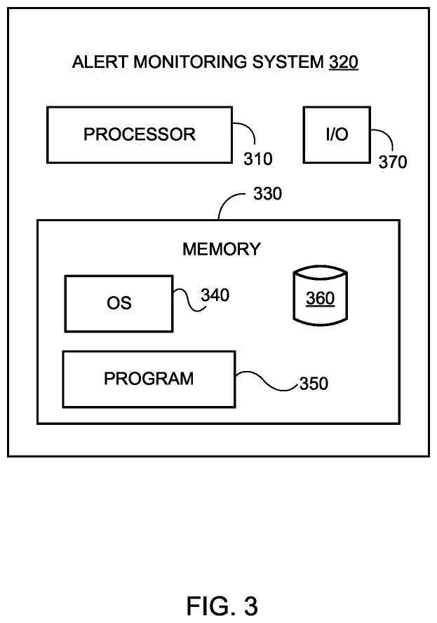

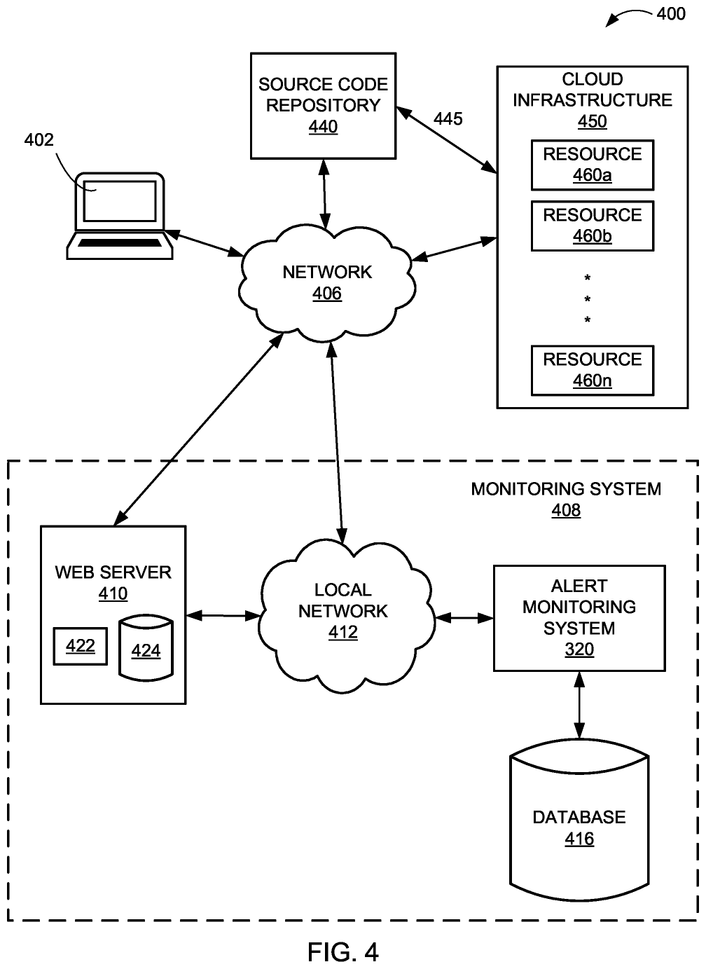

FIG. 1 is a flow diagram illustrating an exemplary method 100 for systems and methods for real time monitoring of cloud resources, in accordance with certain embodiments of the disclosed technology. The steps of method 100 may be performed by one or more components of the system 400 (e.g., alert monitoring system 320 or web server 410 of monitoring system 408 or user device 402), as described in more detail with respect to FIGS. 3 and 4.

In an optional block 102, the alert monitoring system 320 may receive an indication of a code update to source code at a source code repository 440. In some embodiments, the indication of the code update represents replacing a first set of source code with a second set of source code. In some embodiments, the source code repository 440 is a repository that stores source code like GitHub.

In an optional block 104, the alert monitoring system 320 may receive an indication that the second set of source code has been deployed to a cloud infrastructure 450. In some embodiments, the cloud infrastructure 450 may be a collection of hardware and software elements that enable cloud storage and computing. In some embodiments, the cloud infrastructure 450 includes a user interface for managing a plurality of cloud resources 460a-460n. In other embodiments, the cloud infrastructure 450 may be an application.

In block 106, the alert monitoring system 320 may receive an alert associated with an event at an alerting resource. In some embodiments, the alerting resource is one of a plurality of cloud resources 460a-460n hosted on the cloud infrastructure 450. In some embodiments, each of the plurality of cloud resources 460a-460n hosted on the cloud infrastructure 450 includes its own respective monitoring software that monitors an electronic health of the respective cloud resource. In some embodiments, the alert monitoring system 320 may monitor for alerts from cloud resources hosted on the cloud infrastructure 450 by executing code comprising a plurality of listeners. In some embodiments, each of the plurality of listeners is configured to listen for a specified alert event from a specified one of the plurality of cloud resources 460a-460n hosted on the cloud infrastructure 450. In some embodiments, monitoring the electronic health of the respective cloud resource includes monitoring CPU usage, memory usage, and errors. In some embodiments, the alert monitoring system 320 may determine if a metric or a characteristic of the electronic health of the respective cloud resource exceeds a predetermined threshold.

In block 108, the alert monitoring system 320 may identify, based on the alert, one or more interrelated resources. In some embodiments, the one or more interrelated resources are one or more resources of the plurality of cloud resources 460a-460n that may be impacted by the event at the alerting resource. In some embodiments, the plurality of cloud resources 460a-460n may include at least one processor, memory, disk, data, virtualization software, operating system, and other cloud resources known in the art. In some embodiments, the plurality of cloud resources 460a-460n can be at least one AWS resource. In other embodiments, one or more interrelated resources may include a subset of the plurality of cloud resources 460a-460n that are affected by the event.

In block 110, the alert monitoring system 320 may communicate with the cloud infrastructure 450 to obtain a snapshot of resource states. In some embodiments, the snapshot of resource states includes states of the alerting resource and the one or more interrelated resources. In some embodiments, the snapshot of resource states includes performance metrics of the alerting resource and each of the one or more interrelated resources. In some embodiments, the performance metrics includes one or more of: a central processing unit (CPU) utilization, a memory usage, errors, or a combination thereof. In some embodiments, an increase in the CPU utilization or memory usage may be a security attack. In other embodiments, an increase in errors may indicate a security attack.

In block 112, the alert monitoring system 320 may identify a previous update to source code at the source code repository 440 that is suspected of having caused the event. In some embodiments, the previous update is a GitHub commit with a source code update to the source code repository 440 stored in GitHub. In some embodiments, the alert monitoring system 320 may send a command to an AWS Config to receive output data of impacted resources. In some embodiments, identifying the previous update to source code can include identifying the latest update to the source code at the source code repository. In other embodiments, identifying the previous update to source code can include identifying the latest GitHub commit for the source code repository stored in GitHub.

In block 114, the alert monitoring system 320 may generate aggravated alert information. In some embodiments, the aggregated alert information includes an indication of the alert, the snapshot of resource states and an indication of the previous update to source code suspected of having caused the event. In some embodiments, the snapshot of resource states may include an impact assessment related to the previous update or event. In some embodiments, the snapshot of resource states is an impact assessment of each of the impacted resources or the one or more interrelated resources.

In block 116, the alert monitoring system 320 may, responsive to outputting the aggregated alert information to a machine learning model, determine a rectification action. In some embodiments, the rectification action includes automatically reverting the source code to a previous version of source code that was installed on the source code repository 440 prior. In some embodiments, the previous update suspected as having caused the alert is identified as being the code update and the rectification action includes automatically causing the second set of source code to be replaced with the first set of source code at the source code repository 440. In some embodiments, the alert monitoring system 320 may transmit the aggregated alert information output for display via the GUI of the user device 402. In some embodiments, the alert monitoring system 320 may determine if the previous update affected other users apart from the user device 402. In some embodiments, the alert monitoring system 320 may alert the other affected users of the aggregated alert information.

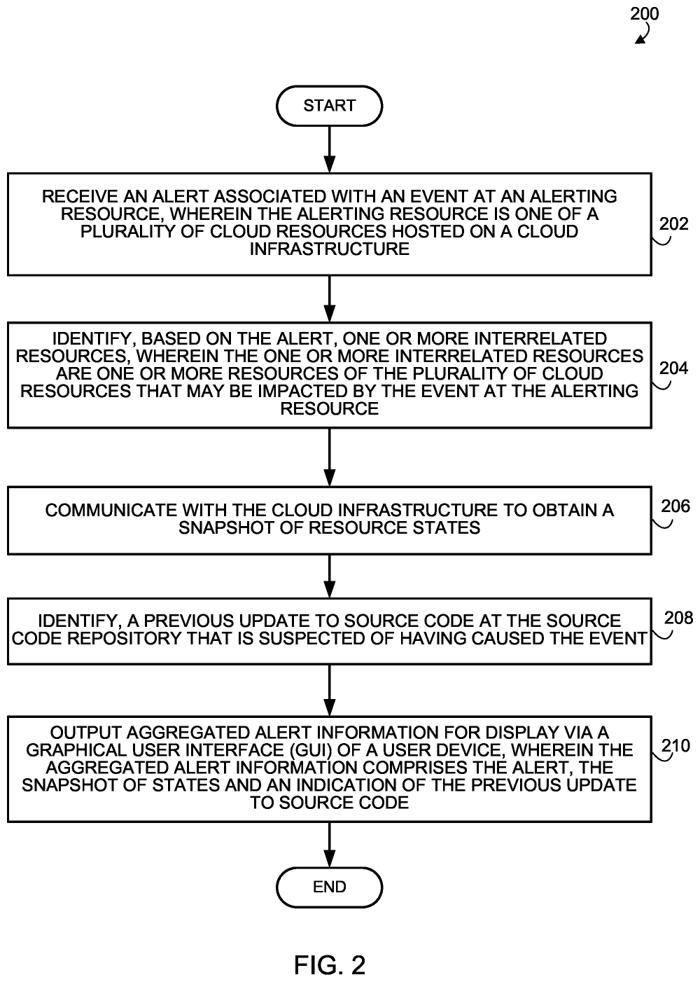

FIG. 2 is a flow diagram illustrating an exemplary method 200 for systems and methods for real time monitoring of cloud resources, in accordance with certain embodiments of the disclosed technology. The steps of method 200 may be performed by one or more components of the system 400 (e.g., alert monitoring system 320 or web server 410 of monitoring system 408 or user device 402), as described in more detail with respect to FIGS. 3 and 4.

Method 200 of FIG. 2 is similar to method 100 of FIG. 1. The descriptions of blocks 202, 204, 206, and 208 in method 200 are similar to the respective descriptions of blocks 106, 108, 110, and 112 of method 100 and are not repeated herein for brevity. However, block 210 is different from block 116 and is described below.

In block 210, the alert monitoring system 320 may output aggregated alert information for display via a graphical user interface (GUI) of a user device 402. In some embodiments, the aggregated alert information includes the alert, the snapshot of states and an indication of the previous update to source code. In other embodiments, the alert monitoring system 320 may iteratively update the aggregated alert information output for display via the GUI of the user device 402 based on iteratively receiving a new alert associated with a new event at a new alerting resource; identifying, based on the new alert, one or more new interrelated resources; communicating with the cloud infrastructure 450 to obtain a new snapshot of resource states; and identifying an update to source code at the source code repository that is suspected of having caused the new event. In some embodiments, the alert monitoring system 320 may in response to displaying the aggregated alert information output for display via the GUI of the user device 402, receive an instruction from the user device 402. In response, the alert monitoring system 320 may automatically revert the source code to a previous version of source code that was previously utilized prior to the previous update that is suspected as having caused the event.

FIG. 3 is a block diagram of an example alert monitoring system 320 used to provide real time monitoring of cloud resources, according to an example implementation of the disclosed technology. According to some embodiments, the user device 402 and web server 410, as depicted in FIG. 4 and described below, may have a similar structure and components that are similar to those described with respect to alert monitoring system 320 shown in FIG. 3. As shown, the alert monitoring system 320 may include a processor 310, an input/output (I/O) device 370, a memory 330 containing an operating system (OS) 340 and a program 350. In certain example implementations, the alert monitoring system 320 may be a single server or may be configured as a distributed computer system including multiple servers or computers that interoperate to perform one or more of the processes and functionalities associated with the disclosed embodiments. In some embodiments alert monitoring system 320 may be one or more servers from a serverless or scaling server system. In some embodiments, the alert monitoring system 320 may further include a peripheral interface, a transceiver, a mobile network interface in communication with the processor 310, a bus configured to facilitate communication between the various components of the alert monitoring system 320, and a power source configured to power one or more components of the alert monitoring system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 may be a single core processor that is configured with virtual processing technologies. In certain embodiments, the processor 310 may use logical processors to simultaneously execute and control multiple processes. The processor 310 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the alert monitoring system 320 may include one or more storage devices configured to store information used by the processor 310 (or other components) to perform certain functions related to the disclosed embodiments. In one example, the alert monitoring system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The alert monitoring system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the alert monitoring system 320 may include the memory 330 that may include one or more programs 350 to perform one or more functions of the disclosed embodiments. For example, in some embodiments, the alert monitoring system 320 may additionally manage dialogue and/or other interactions with the customer via a program 350.

The processor 310 may execute one or more programs 350 located remotely from the alert monitoring system 320. For example, the alert monitoring system 320 may access one or more remote programs that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include an alert monitoring system database 360 for storing related data to enable the alert monitoring system 320 to perform one or more of the processes and functionalities associated with the disclosed embodiments.

The alert monitoring system database 360 may include stored data relating to status data (e.g., average session duration data, location data, idle time between sessions, and/or average idle time between sessions) and historical status data. According to some embodiments, the functions provided by the alert monitoring system database 360 may also be provided by a database that is external to the alert monitoring system 320, such as the database 416 as shown in FIG. 4.

The alert monitoring system 320 may also be communicatively connected to one or more memory devices (e.g., databases) locally or through a network. The remote memory devices may be configured to store information and may be accessed and/or managed by the alert monitoring system 320. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The alert monitoring system 320 may also include one or more I/O devices 370 that may include one or more interfaces for receiving signals or input from devices and providing signals or output to one or more devices that allow data to be received and/or transmitted by the alert monitoring system 320. For example, the alert monitoring system 320 may include interface components, which may provide interfaces to one or more input devices, such as one or more keyboards, mouse devices, touch screens, track pads, trackballs, scroll wheels, digital cameras, microphones, sensors, and the like, that enable the alert monitoring system 320 to receive data from a user (such as, for example, via the user device 402).

In examples of the disclosed technology, the alert monitoring system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The alert monitoring system 320 may contain programs that train, implement, store, receive, retrieve, and/or transmit one or more machine learning models. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The alert monitoring system 320 may be configured to adjust model parameters during training. Model parameters may include weights, coefficients, offsets, or the like. Training may be supervised or unsupervised.

The alert monitoring system 320 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The alert monitoring system 320 may be configured to optimize statistical models using known optimization techniques.

Furthermore, the alert monitoring system 320 may include programs configured to retrieve, store, and/or analyze properties of data models and datasets. For example, alert monitoring system 320 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model.

The alert monitoring system 320 may include algorithms to determine a data type, key-value pairs, row-column data structure, statistical distributions of information such as keys or values, or other property of a data schema may be configured to return a statistical profile of a dataset (e.g., using a data-profiling model). The alert monitoring system 320 may be configured to implement univariate and multivariate statistical methods. The alert monitoring system 320 may include a regression model, a Bayesian model, a statistical model, a linear discriminant analysis model, or other classification model configured to determine one or more descriptive metrics of a dataset. For example, alert monitoring system 320 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The alert monitoring system 320 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, alert monitoring system 320 may be configured to generate a similarity metric representing a measure of similarity between data in a dataset. A similarity metric may be based on a correlation, covariance matrix, a variance, a frequency of overlapping values, or other measure of statistical similarity.

The alert monitoring system 320 may be configured to generate a similarity metric based on data model output, including data model output representing a property of the data model. For example, alert monitoring system 320 may be configured to generate a similarity metric based on activation function values, embedding layer structure and/or outputs, convolution results, entropy, loss functions, model training data, or other data model output). For example, a synthetic data model may produce first data model output based on a first dataset and a produced data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The alert monitoring system 320 may be configured to classify a dataset. Classifying a dataset may include determining whether a dataset is related to another datasets. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The alert monitoring system 320 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some embodiments, alert monitoring system 320 is configured to generate and/or train a classification model to classify a dataset, consistent with disclosed embodiments.

While the alert monitoring system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the alert monitoring system 320 may include a greater or lesser number of components than those illustrated.

FIG. 4 is a block diagram of an example system that may be used to view and interact with monitoring system 408, according to an example implementation of the disclosed technology. The components and arrangements shown in FIG. 4 are not intended to limit the disclosed embodiments as the components used to implement the disclosed processes and features may vary. As shown, monitoring system 408 may interact with a user device 402, source code repository 440, or a cloud infrastructure 450 via a network 406. In certain example implementations, the monitoring system 408 may include a local network 412, an alert monitoring system 320, a web server 410, and a database 416.

In some embodiments, a user may operate the user device 402. The user device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the monitoring system 408. In some embodiments, the user device 402 may include or incorporate electronic communication devices for hearing or vision impaired users.

According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

In some embodiments, the source code repository may be any suitable repository of data. Information stored in the source code repository may be accessed (e.g., retrieved, updated, and added to) via the local network 412 (and/or the network 406) by one or more devices of the system 400. In some embodiments, the information stored in the source code repository may be software code or source code. In some embodiments, as shown, the source code repository 440 may interact 445 with the cloud infrastructure 450. In some embodiments, the cloud infrastructure can include resource 460a-460n.

The alert monitoring system 320 may include programs (scripts, functions, algorithms) to configure data for visualizations and provide visualizations of datasets and data models on the user device 402. This may include programs to generate graphs and display graphs. The alert monitoring system 320 may include programs to generate histograms, scatter plots, time series, or the like on the user device 402. The alert monitoring system 320 may also be configured to display properties of data models and data model training results including, for example, architecture, loss functions, cross entropy, activation function values, embedding layer structure and/or outputs, convolution results, node outputs, or the like on the user device 402.

The network 406 may be of any suitable type, including individual connections via the internet such as cellular or WiFi networks. In some embodiments, the network 406 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The monitoring system 408 may be associated with and optionally controlled by one or more entities such as a business, corporation, individual, partnership, or any other entity that provides one or more of goods, services, and consultations to individuals such as customers. In some embodiments, the monitoring system 408 may be controlled by a third party on behalf of another business, corporation, individual, partnership, etc. The monitoring system 408 may include one or more servers and computer systems for performing one or more functions associated with products and/or services that the organization provides.

Web server 410 may include a computer system configured to generate and provide one or more websites accessible to customers, as well as any other individuals involved in access system 408's normal operations. Web server 410 may include a computer system configured to receive communications from user device 402 via, for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the user device 402. For example, web server 410 may host a financial service provider website that a user device may access by providing an attempted login that is authenticated by the alert monitoring system 320. According to some embodiments, web server 410 may include software tools, similar to those described with respect to user device 402 above, that may allow web server 410 to obtain network identification data from user device 402. The web server may also be hosted by an online provider of website hosting, networking, cloud, or backup services, such as Microsoft Azure™ or Amazon Web Services™.

The local network 412 may include any type of computer networking arrangement used to exchange data in a localized area, such as WiFi, Bluetooth™, Ethernet, and other suitable network connections that enable components of the monitoring system 408 to interact with one another and to connect to the network 406 for interacting with components in the system 400 environment. In some embodiments, the local network 412 may include an interface for communicating with or linking to the network 406. In other embodiments, certain components of the monitoring system 408 may communicate via the network 406, without a separate local network 406.

The monitoring system 408 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 402 may be able to access monitoring system 408 using the cloud computing environment. User device 402 may be able to access monitoring system 408 using specialized software. The cloud computing environment may eliminate the need to install specialized software on user device 402.

In accordance with certain example implementations of the disclosed technology, the monitoring system 408 may include one or more computer systems configured to compile data from a plurality of sources, such as, but not limited to, the alert monitoring system 320, web server 410, and/or the database 416. The alert monitoring system 320 may correlate compiled data, analyze the compiled data, arrange the compiled data, generate derived data based on the compiled data, and store the compiled and derived data in a database such as the database 416. According to some embodiments, the database 416 may be a database associated with an organization and/or a related entity that stores a variety of information relating to customers, transactions, ATM, and business operations. The database 416 may also serve as a back-up storage device and may contain data and information that is also stored on, for example, database 360, as discussed with reference to FIG. 3.

Embodiments consistent with the present disclosure may include datasets. Datasets may include actual data reflecting real-world conditions, events, and/or measurements. However, in some embodiments, disclosed systems and methods may fully or partially involve synthetic data (e.g., anonymized actual data or fake data). Datasets may involve numeric data, text data, and/or image data. For example, datasets may include transaction data, financial data, demographic data, public data, government data, environmental data, traffic data, network data, transcripts of video data, genomic data, proteomic data, and/or other data. Datasets of the embodiments may be in a variety of data formats including, but not limited to, PARQUET, AVRO, SQLITE, POSTGRESQL, MYSQL, ORACLE, HADOOP, CSV, JSON, PDF, JPG, BMP, and/or other data formats.

Datasets of disclosed embodiments may have a respective data schema (e.g., structure), including a data type, key-value pair, label, metadata, field, relationship, view, index, package, procedure, function, trigger, sequence, synonym, link, directory, queue, or the like. Datasets of the embodiments may contain foreign keys, for example, data elements that appear in multiple datasets and may be used to cross-reference data and determine relationships between datasets. Foreign keys may be unique (e.g., a personal identifier) or shared (e.g., a postal code). Datasets of the embodiments may be “clustered,” for example, a group of datasets may share common features, such as overlapping data, shared statistical properties, or the like. Clustered datasets may share hierarchical relationships (e.g., data lineage).

### EXAMPLE USE CASE

The following example use case describes an example of a typical user flow pattern. This section is intended solely for explanatory purposes and not in limitation.

In one example, a customer John has a program with source code that is being monitored. In this example, an alert monitoring system 320 receives an indication of a code update to the source code being stored at a source code repository. In this example, the indication of the code update represents a second set of source code that replaced a first set of source code. The alert monitoring system 320 then receives an indication that the second set of source code has been deployed to a cloud infrastructure 450. The alert monitoring system 320 then receives an alert associated with an event at an alerting resource. In this example, the event is a security event, and the alerting resource is one of a plurality of cloud resources 460a-460n hosted on the cloud infrastructure 450. The alert monitoring system 320 then identifies, based on the alert, one or more interrelated resources. The one or more interrelated resources can include one or more resources of the plurality of cloud resources 460a-460n that may be impacted by the event at the alerting resource. The alert monitoring system 320 can then communicate with the cloud infrastructure 450 to obtain a snapshot of resource states and identify, a previous update to source code at the source code repository that is suspected of having caused the event. Once the previous update is identified, the alert monitoring system 320 generates aggregated alert information. In some embodiments, the aggregated alert information includes an indication of the alert, the snapshot of resource includes an indication of the previous update to source code suspected of having caused the event. Then the alert monitoring system 320 can in response to outputting the aggregated alert information to a machine learning model, determine a rectification action such as reverting the program to a previous version of source code that was previously utilized prior to the previous update that is suspected as having caused the event.

In some examples, disclosed systems or methods may involve one or more of the following clauses:

Clause 1: A system comprising: one or more processors; and a memory in communication with the one or more processors and storing instructions that, when executed by the one or more processors, are configured to cause the system to: receive an indication of a code update to source code at a source code repository, wherein the indication of the code update represents replacing a first set of source code with a second set of source code; receive an indication that the second set of source code has been deployed to a cloud infrastructure; receive an alert associated with an event at an alerting resource, wherein the alerting resource is one of a plurality of cloud resources hosted on the cloud infrastructure; identify, based on the alert, one or more interrelated resources, wherein the one or more interrelated resources comprise one or more resources of the plurality of cloud resources that may be impacted by the event at the alerting resource; communicate with the cloud infrastructure to obtain a snapshot of resource states; identify, a previous update to source code at the source code repository that is suspected of having caused the event; generate aggregated alert information, wherein the aggregated alert information comprises an indication of the alert, the snapshot of resource states and an indication of the previous update to source code suspected of having caused the event; and responsive to outputting the aggregated alert information to a machine learning model, determine a rectification action.

Clause 2: The system of clause 1, wherein the snapshot of resource states comprises states of the alerting resource and the one or more interrelated resources.

Clause 3: The system of clause 2, wherein the snapshot of resource states comprises performance metrics of the alerting resource and each of the one or more interrelated resources.

Clause 4: The system of clause 3, wherein the performance metrics comprise one or more of: a central processing unit (CPU) utilization; a memory usage; and errors.

Clause 5: The system of clause 1, wherein each of the plurality of cloud resources hosted on the cloud infrastructure comprises its own respective monitoring software that monitors an electronic health of the respective cloud resource.

Clause 6: The system of clause 5, wherein the instructions are further configured to cause the system to: monitor for alerts from cloud resources hosted on the cloud infrastructure by: executing code comprising a plurality of listeners, wherein each of the plurality of listeners is configured to listen for a specified alert event from a specified one of the plurality of cloud resources hosted on the cloud infrastructure.

Clause 7: The system of clause 1, wherein the previous update suspected as having caused the alert is identified as being the code update and the rectification action comprises automatically causing the second set of source code to be replaced with the first set of source code at the source code repository.

Clause 8: A system comprising: one or more processors; and a memory in communication with the one or more processors and storing instructions that, when executed by the one or more processors, are configured to cause the system to: receive an alert associated with an event at an alerting resource, wherein the alerting resource is one of a plurality of cloud resources hosted on a cloud infrastructure; identify, based on the alert, one or more interrelated resources, wherein the one or more interrelated resources comprise one or more resources of the plurality of cloud resources that may be impacted by the event at the alerting resource; communicate with the cloud infrastructure to obtain a snapshot of resource states; identify, a previous update to source code at a source code repository that is suspected of having caused the event; generate aggregated alert information, wherein the aggregated alert information comprises an indication of the alert, the snapshot of resource states and an indication of the previous update to source code suspected of having caused the event; and responsive to outputting the aggregated alert information to a machine learning model, determine a rectification action.

Clause 9: The system of clause 8, wherein the snapshot of resource states comprises states of the alerting resource and the one or more interrelated resources.

Clause 10: The system of clause 9, wherein the snapshot of resource states comprises performance metrics of the alerting resource and each of the one or more interrelated resources.

Clause 11: The system of clause 10, wherein the performance metrics comprise one or more of: a central processing unit (CPU) utilization; a memory usage; and errors.

Clause 12: The system of clause 8, wherein each of the plurality of cloud resources hosted on the cloud infrastructure comprises its own respective monitoring software that monitors an electronic health of the respective cloud resource.

Clause 13: The system of clause 12, wherein the instructions are further configured to cause the system to: monitor for alerts from cloud resources hosted on the cloud infrastructure by: executing code comprising a plurality of listeners, wherein each of the plurality of listeners is configured to listen for a specified alert event from a specified one of the plurality of cloud resources hosted on the cloud infrastructure.

Clause 14: The system of clause 8, wherein the rectification action comprises automatically reverting the source code to a previous version of source code that was installed on the source code repository prior.

Clause 15: A system comprising: one or more processors; and a memory in communication with the one or more processors and storing instructions that, when executed by the one or more processors, are configured to cause the system to: receive an alert associated with an event at an alerting resource, wherein the alerting resource is one of a plurality of cloud resources hosted on a cloud infrastructure; identify, based on the alert, one or more interrelated resources, wherein the one or more interrelated resources comprise one or more resources of the plurality of cloud resources that may be impacted by the event at the alerting resource; communicate with the cloud infrastructure to obtain a snapshot of resource states; identify, a previous update to source code at a source code repository that is suspected of having caused the event; and output aggregated alert information for display via a graphical user interface (GUI) of a user device, wherein the aggregated alert information comprises the alert, the snapshot of states and an indication of the previous update to source code.

Clause 16: The system of clause 15, wherein the instructions are further configured to cause the system to iteratively update the aggregated alert information output for display via the GUI of the user device based on iteratively: receiving a new alert associated with a new event at a new alerting resource; identifying, based on the new alert, one or more new interrelated resources; communicating with the cloud infrastructure to obtain a new snapshot of resource states; and identifying an update to source code at the source code repository that is suspected of having caused the new event.

Clause 17: The system of clause 15, wherein the snapshot of resource states comprises performance metrics of the alerting resource and each of the one or more interrelated resources.

Clause 18: The system of clause 15, wherein each of the plurality of cloud resources hosted on the cloud infrastructure comprises its own respective monitoring software that monitors an electronic health of the respective cloud resource.

Clause 19: The system of clause 18, wherein the instructions are further configured to cause the system to: monitor for alerts from cloud resources hosted on the cloud infrastructure by: executing code comprising a plurality of listeners, wherein each of the plurality of listeners is configured to listen for a specified alert event from a specified one of the plurality of cloud resources hosted on the cloud infrastructure.

Clause 20: The system of clause 15, where the instructions are further configured to cause the system to: responsive to receiving an instruction from the user device, automatically revert the source code to a previous version of source code that was previously utilized prior to the previous update that is suspected as having caused the event.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
one or more processors; and
a memory in communication with the one or more processors and storing instructions that, when executed by the one or more processors, are configured to cause the system to:
receive an indication of a code update to source code at a source code repository, wherein the indication of the code update represents replacing a first set of source code with a second set of source code;
receive an indication that the second set of source code has been deployed to a cloud infrastructure;
receive an alert associated with an event at an alerting resource, wherein the alerting resource is one of a plurality of cloud resources hosted on the cloud infrastructure;
identify, based on the alert, one or more interrelated resources, wherein the one or more interrelated resources comprise one or more resources of the plurality of cloud resources that may be impacted by the event at the alerting resource;
communicate with the cloud infrastructure to obtain a snapshot of resource states;
identify, a previous update to source code at the source code repository that is suspected of having caused the event;
generate aggregated alert information, wherein the aggregated alert information comprises an indication of the alert, the snapshot of resource states and an indication of the previous update to source code suspected of having caused the event; and
responsive to outputting the aggregated alert information to a machine learning model, determine a rectification action.

2. The system of claim 1, wherein the snapshot of resource states comprises states of the alerting resource and the one or more interrelated resources.

3. The system of claim 2, wherein the snapshot of resource states comprises performance metrics of the alerting resource and each of the one or more interrelated resources.

4. The system of claim 3, wherein the performance metrics comprise one or more of:
a central processing unit (CPU) utilization;
a memory usage; and
errors.

5. The system of claim 1, wherein each of the plurality of cloud resources hosted on the cloud infrastructure comprises its own respective monitoring software that monitors an electronic health of the respective cloud resource.

6. The system of claim 5, wherein the instructions are further configured to cause the system to:
monitor for alerts from cloud resources hosted on the cloud infrastructure by:
executing code comprising a plurality of listeners, wherein each of the plurality of listeners is configured to listen for a specified alert event from a specified one of the plurality of cloud resources hosted on the cloud infrastructure.

7. The system of claim 1, wherein the previous update suspected as having caused the alert is identified as being the code update and the rectification action comprises automatically causing the second set of source code to be replaced with the first set of source code at the source code repository.

8. A system comprising:
one or more processors; and
a memory in communication with the one or more processors and storing instructions that, when executed by the one or more processors, are configured to cause the system to:
receive an alert associated with an event at an alerting resource, wherein the alerting resource is one of a plurality of cloud resources hosted on a cloud infrastructure;
identify, based on the alert, one or more interrelated resources, wherein the one or more interrelated resources comprise one or more resources of the plurality of cloud resources that may be impacted by the event at the alerting resource;
communicate with the cloud infrastructure to obtain a snapshot of resource states;
identify, a previous update to source code at a source code repository that is suspected of having caused the event;
generate aggregated alert information, wherein the aggregated alert information comprises an indication of the alert, the snapshot of resource states and an indication of the previous update to source code suspected of having caused the event; and
responsive to outputting the aggregated alert information to a machine learning model, determine a rectification action.

9. The system of claim 8, wherein the snapshot of resource states comprises states of the alerting resource and the one or more interrelated resources.

10. The system of claim 9, wherein the snapshot of resource states comprises performance metrics of the alerting resource and each of the one or more interrelated resources.

11. The system of claim 10, wherein the performance metrics comprise one or more of:
a central processing unit (CPU) utilization;
a memory usage; and
errors.

12. The system of claim 8, wherein each of the plurality of cloud resources hosted on the cloud infrastructure comprises its own respective monitoring software that monitors an electronic health of the respective cloud resource.

13. The system of claim 12, wherein the instructions are further configured to cause the system to:
monitor for alerts from cloud resources hosted on the cloud infrastructure by:
executing code comprising a plurality of listeners, wherein each of the plurality of listeners is configured to listen for a specified alert event from a specified one of the plurality of cloud resources hosted on the cloud infrastructure.

14. The system of claim 8, wherein the rectification action comprises automatically reverting the source code to a previous version of source code that was installed on the source code repository prior.

15. A system comprising:
one or more processors; and
a memory in communication with the one or more processors and storing instructions that, when executed by the one or more processors, are configured to cause the system to:
receive an alert associated with an event at an alerting resource, wherein the alerting resource is one of a plurality of cloud resources hosted on a cloud infrastructure;
identify, based on the alert, one or more interrelated resources, wherein the one or more interrelated resources comprise one or more resources of the plurality of cloud resources that may be impacted by the event at the alerting resource;
communicate with the cloud infrastructure to obtain a snapshot of resource states;
identify, a previous update to source code at a source code repository that is suspected of having caused the event; and
output aggregated alert information for display via a graphical user interface (GUI) of a user device, wherein the aggregated alert information comprises the alert, the snapshot of states and an indication of the previous update to source code.

16. The system of claim 15, wherein the instructions are further configured to cause the system to iteratively update the aggregated alert information output for display via the GUI of the user device based on iteratively:
receiving a new alert associated with a new event at a new alerting resource;
identifying, based on the new alert, one or more new interrelated resources;
communicating with the cloud infrastructure to obtain a new snapshot of resource states; and
identifying an update to source code at the source code repository that is suspected of having caused the new event.

17. The system of claim 15, wherein the snapshot of resource states comprises performance metrics of the alerting resource and each of the one or more interrelated resources.

18. The system of claim 15, wherein each of the plurality of cloud resources hosted on the cloud infrastructure comprises its own respective monitoring software that monitors an electronic health of the respective cloud resource.

19. The system of claim 18, wherein the instructions are further configured to cause the system to:
monitor for alerts from cloud resources hosted on the cloud infrastructure by:
executing code comprising a plurality of listeners, wherein each of the plurality of listeners is configured to listen for a specified alert event from a specified one of the plurality of cloud resources hosted on the cloud infrastructure.

20. The system of claim 15, where the instructions are further configured to cause the system to:
responsive to receiving an instruction from the user device, automatically revert the source code to a previous version of source code that was previously utilized prior to the previous update that is suspected as having caused the event.
